(19) United States
(12) Patent Application Publication
(10) Pub. No.: US 2025/0352933 A1
(43) Pub. Date: Nov. 20, 2025

(54) Fluid Device

(71) Applicant: SEIKO EPSON CORPORATION, Tokyo (JP)

(72) Inventors: Tatsuki JONAI, Matsumoto (JP); Keita KUBO, Shiojiri (JP); Seiji IZUO, Shiojiri (JP); Hiroto TOMIOKA, Shiojiri (JP)

(21) Appl. No.: 19/209,041

(22) Filed: May 15, 2025

(30) Foreign Application Priority Data
May 16, 2024 (JP) 2024-080172

(51) Int. Cl. B01D 43/00

(52) U.S. Cl. CPC B01D 43/00; B01D 2259/816

(57) ABSTRACT

A fluid device 10 that separates microparticles in a fluid using ultrasonic waves, the fluid device 10 includes an inflow flow path 20 through which the fluid flows; a separation flow path 30 into which the fluid flows from the inflow flow path 20; a first outflow flow path 40 that causes the fluid to flow out from the separation flow path 30; a second outflow flow path 50 that causes the fluid to flow out from the separation flow path 30; and an ultrasonic transmitter 60 that transmits the ultrasonic waves to the separation flow path 30 and at least one of the inflow flow path 20 and the first outflow flow path 40, and forms a standing wave along a first direction in each flow path to which the ultrasonic waves were transmitted.

The present application is based on, and claims priority from JP Application Serial Number 2024-080172, filed May 16, 2024, the disclosure of which is hereby incorporated by reference herein in its entirety.

### BACKGROUND

### 1. Technical Field

The present disclosure relates to a fluid device.

### 2. Related Art

In the related art, a fluid device that acoustically focuses microparticles in a fluid is known. For example, in the fluid device disclosed in JP-A-9-122480, an ultrasonic element transmits ultrasonic waves to form standing waves in a fluid in a separation flow path, and the pressure gradient of the standing waves causes microparticles in the fluid to be captured at nodes of the standing waves. The captured microparticles flow from the separation flow path to a concentrated fluid outlet and the diluted fluid flows from the separation flow path to a diluted fluid outlet.

However, in the fluid device disclosed in JP-A-9-122480, the behavior of the microparticles cannot be controlled immediately before the microparticles are captured by the nodes of the standing waves in the separation flow path or immediately after the microparticles are released from the nodes of the standing waves in the separation flow path, and the improvement of the concentration efficiency of the microparticles is not sufficient.

### SUMMARY

A fluid device according to an aspect of the present disclosure is a fluid device that separates microparticles in a fluid using ultrasonic waves, the fluid device including an inflow flow path through which the fluid flows; a separation flow path into which the fluid flows from the inflow flow path; a first outflow flow path that causes the fluid to flow out from the separation flow path; a second outflow flow path that causes the fluid to flow out from the separation flow path; and an ultrasonic transmitter that transmits the ultrasonic waves to the separation flow path and at least one of the inflow flow path and the first outflow flow path, and forms a standing wave along a first direction in each flow path to which the ultrasonic waves were transmitted.

### BRIEF DESCRIPTION OF THE DRAWINGS

FIG. 1 is a cross-sectional view schematically showing a fluid device according to a first embodiment.

FIG. 2 is a graph showing a simulation result of a sound pressure applied to microparticles in the first embodiment.

FIG. 3 is a cross-sectional view schematically showing a fluid device according to a second embodiment.

FIG. 4 is a cross-sectional view schematically showing a fluid device according to a third embodiment.

FIG. 5 is a cross-sectional view schematically showing a fluid device according to a fourth embodiment.

### DESCRIPTION OF EMBODIMENTS

Hereinafter, a plurality of embodiments of the present disclosure will be described with reference to the drawings. In a second and subsequent embodiments, the same components as those of a first embodiment are denoted by the same reference symbols as those of the first embodiment, and the description thereof will be omitted or simplified.

### First Embodiment

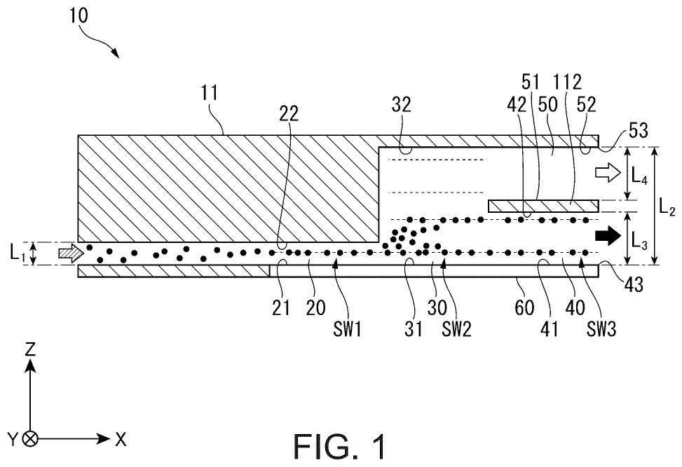

FIG. 1 is a cross-sectional view schematically showing a fluid device 10 of the present embodiment. As shown in FIG. 1, the fluid device 10 includes an inflow flow path 20, a separation flow path 30, a first outflow flow path 40, a second outflow flow path 50, and an ultrasonic transmitter 60.

The fluid device 10 of the present embodiment acoustically focuses microparticles in fluid flowing from the inflow flow path 20 into the separation flow path 30, causes fluid in which the microparticles are concentrated to flow out from the first outflow flow path 40, and causes fluid in which the microparticles are diluted or removed to flow out from the second outflow flow path 50. The fluid is not particularly limited, and may be any liquid such as water, for example. The microparticles are not particularly limited, and are, for example, microfibers or microplastics.

In the present embodiment, each of the inflow flow path 20, the separation flow path 30, the first outflow flow path 40, and the second outflow flow path 50 is arranged along an arbitrary first direction, and allows the fluid to flow along the first direction. Here, a flow direction of the fluid in each flow path is set as an X direction, an upstream side in the flow direction of the fluid is set as a −X side, and a downstream side in the flow direction of the fluid is set as a +X side. A direction that is a first direction orthogonal to the X direction and in which standing waves SW1 to SW3 (to be described later) are formed is set as a Z direction, one side of the Z direction is set as a +Z direction, and the other side of the Z direction is set as a −Z direction. A direction orthogonal to each of the X direction and the Z direction is set as a Y direction.

In the present embodiment, the entire flow path including the inflow flow path 20, the separation flow path 30, the first outflow flow path 40, and the second outflow flow path 50 is mainly formed by a flow path member 11. The flow path member 11 is made of a material capable of reflecting ultrasonic waves in the fluid, for example, a material having an acoustic impedance different from that of the fluid.

The inflow flow path 20 is a flow path through which the fluid containing the microparticles flows into the separation flow path 30. A −X side end section of the inflow flow path 20 is connected to an introduction pipe (not shown) that introduces the fluid into the fluid device 10, and a +X side end section of the inflow flow path 20 is connected to a −X side end section of the separation flow path 30. A flow path width L₁ of the inflow flow path 20 in the Z direction is defined by a pair of flat wall surfaces 21 and 22 facing each other in the Z direction.

The separation flow path 30 is an intermediate flow path through which the fluid flowing in from the inflow flow path 20 flows out to each of the first outflow flow path 40 and the second outflow flow path 50. A flow path width L₂ of the separation flow path 30 in the Z direction is defined by a pair of flat wall surfaces 31 and 32 facing each other in the Z direction. The flow path width L₂ of the separation flow path 30 is larger than the flow path width L₁ of the inflow flow path 20. The wall surface 31 of the separation flow path 30 on a −Z side is continuous with the wall surface 21 of the inflow flow path 20 on a −Z side in the X direction.

The first outflow flow path 40 and the second outflow flow path 50 are flow paths that allow the fluid to flow out from the separation flow path 30, and are connected in parallel to each other in the Z direction to a +X side end section of the separation flow path 30.

The first outflow flow path 40 is arranged at a position facing the inflow flow path 20 in the Z direction with the separation flow path 30 interposed therebetween. In other words, a Z-direction range in which the inflow flow path 20 is arranged is included in a Z-direction range in which the first outflow flow path 40 is arranged.

A +X side end section of the first outflow flow path 40 forms a concentration port 43 from which the fluid flowing in from the separation flow path 30 flows out. A flow path width L₃ of the first outflow flow path 40 in the Z direction is defined by a pair of flat wall surfaces 41 and 42 facing each other in the Z direction. The flow path width L₃ of the first outflow flow path 40 is larger than the flow path width L₁ of the inflow flow path 20 and smaller than the flow path width L₂ of the separation flow path 30. The wall surface 41 of the first outflow flow path 40 on a −Z side is continuous with the wall surface 31 of the separation flow path 30 on a −Z side in the X direction.

The second outflow flow path 50 is arranged on a +Z side of the first outflow flow path 40. A +X side end section of the second outflow flow path 50 forms a purification port 53 through which the fluid flowing in from the separation flow path 30 flows out. A flow path width L₄ of the second outflow flow path 50 is defined by a pair of flat wall surfaces 51 and 52 facing each other in the Z direction.

The first outflow flow path 40 and the second outflow flow path 50 are partitioned by a partition 112. In other words, the flow path member 11 includes the partition 112 that partitions the first outflow flow path 40 and the second outflow flow path 50 from each other. The partition 112 forms the wall surface 42 on a +Z side of the first outflow flow path 40 and the wall surface 51 on a −Z side of the second outflow flow path 50.

In the present embodiment, the total dimension of the flow path width L₃ of the first outflow flow path 40, the flow path width L₄ of the second outflow flow path 50, and the Z-direction dimension of the partition 112 is equal to the flow path width L₂ of the separation flow path 30.

The ultrasonic transmitter 60 is arranged across the inflow flow path 20, the separation flow path 30, and the first outflow flow path 40, and transmits ultrasonic waves to these flow paths. Specifically, the ultrasonic transmitter 60 of the present embodiment is composed of one ultrasonic element, and this ultrasonic element is provided in the flow path member 11 so as to form each of the wall surfaces 21, 31, and 41 of the inflow flow path 20, the separation flow path 30 and the first outflow flow path 40.

The ultrasonic transmitter 60 does not have to be arranged across the entire length of the inflow flow path 20, but only needs to be arranged so as to overlap at least a region of the inflow flow path 20 adjacent to the separation flow path 30. Similarly, the ultrasonic transmitter 60 does not have to be arranged across the entire length of the first outflow flow path 40, but only needs to be arranged so as to overlap at least a region of the first outflow flow path 40 adjacent to the separation flow path 30.

The specific configuration of the ultrasonic element constituting the ultrasonic transmitter 60 is not particularly limited. The ultrasonic element of the present embodiment may be a bulk type ultrasonic element or a thin film type ultrasonic element. The thin film type ultrasonic element includes a substrate in which one or more opening sections are formed, a thin film-shaped vibration section that covers each opening section of the substrate, and a piezoelectric element that is arranged in each vibration section, and a combination of the vibration section and the piezoelectric element configures an ultrasonic transducer. For example, the thin film type ultrasonic element may include one ultrasonic transducer, or may include a plurality of ultrasonic transducers arranged in an array.

In the present embodiment, the ultrasonic waves transmitted from the ultrasonic transmitter 60 have a frequency capable of forming standing waves SW1 to SW3 in the Z direction in the respective flow paths of the inflow flow path 20, the separation flow path 30, and the first outflow flow path 40. In other words, the inflow flow path 20, the separation flow path 30 and the first outflow flow path 40 have flow the path widths L₁, L₂, and L₃, respectively, that form the standing waves SW1 to SW3, respectively, in the Z direction by reflecting the ultrasonic waves transmitted from the ultrasonic transmitter 60 in the Z direction. In FIG. 1, nodes of the standing waves SW1 to SW3 are shown as dotted lines (lines parallel to the X direction), and the microparticles in the fluid are shown as black circles.

Here, each flow path width L (L₁, L₂, L₃) of the inflow flow path 20, the separation flow path 30, and the first outflow flow path 40 is designed to satisfy the following formula (1). Here, f is the frequency of the ultrasonic waves transmitted from the ultrasonic transmitter 60, C₀ is the speed of sound in the fluid, n is the order of the standing waves SW1 to SW3 in each flow path.

$$\begin{matrix}Equation 1 & \\ f = \frac{{nC}_{0}}{L} & formula ( 1 )\end{matrix}$$

When the above-described formula (1) is converted, each flow path width L (L₁, L₂, L₃) of the inflow flow path 20, the separation flow path 30 and the first outflow flow path 40 satisfies the following formula (2). That is, each of the flow path widths L is designed to be an integral multiple of a half wavelength (λ/2) of the ultrasonic wave transmitted from the ultrasonic transmitter 60.

$$\begin{matrix}Equation 2 & \\ L = \frac{λ}{2} n & formula ( 2 )\end{matrix}$$

In the present embodiment, since the frequencies of the standing waves SW1 to SW3 formed in the respective flow paths of the inflow flow path 20, the separation flow path 30, and the first outflow flow path 40 are equal to each other, the following formula (3) is established. Here, n₁ is the order of the standing wave SW1 in the inflow flow path 20, n₂ is the order of the standing wave SW2 in the separation flow path 30, and n₃ is the order of the standing wave SW3 in the first outflow flow path 40.

$$\begin{matrix}Equation 3 & \\ f = \frac{{n}_{1} {C}_{0}}{2 {L}_{1}} = \frac{{n}_{2} {C}_{0}}{2 {L}_{2}} = \frac{{n}_{3} {C}_{0}}{2 {L}_{3}} & formula ( 3 )\end{matrix}$$

According to the above-described formula (3), the flow path width L₁ of the inflow flow path 20, the flow path width L₂ of the separation flow path 30, and the flow path width L₃ of the first outflow flow path 40 satisfy the relationships of the following formulas (4) and (5).

$$\begin{matrix}Equation 4 & \\ {L}_{2} = \frac{{n}_{2}}{{n}_{1}} {L}_{1} & formula ( 4 )\end{matrix}$$

In the present embodiment, the flow path width L₂ of the separation flow path 30 and the flow path width L₃ of the first outflow flow path 40 are each designed to be an integral multiple of the flow path width L₁ of the inflow flow path 20. Therefore, n₂/n₁ and n₃/n₁ in the above-described formulas (4) and (5) are each assumed to be integers.

According to such a flow path design, a node of the standing wave SW1 in the inflow flow path 20 is arranged at the same position in the Z direction with respect to any node of the standing wave SW2 in the separation flow path 30 and any node of the standing wave SW3 in the first outflow flow path 40. In other words, each standing wave SW1 to SW3 formed in the inflow flow path 20, the separation flow path 30 and the first outflow flow path 40 has a node arranged at the same position to each other in the Z direction.

For example, in the present embodiment, the order n₁ of the standing wave SW1 formed in the inflow flow path 20 is 1, the order n₂ of the standing wave SW2 formed in the separation flow path 30 is 4, the order n₃ of the standing wave SW3 formed in the first outflow flow path 40 is 2. Therefore, a node of the standing wave SW1 in the inflow flow path 20 is arranged at the same position in the Z direction as a first node from a −Z side of the standing wave SW2 in the separation flow path 30 (specifically, a first node counted in the +Z direction from the wall surface 31 on a −Z side of the separation flow path 30) and a first node from a −Z side of the standing wave SW3 in the first outflow flow path 40 (specifically, a first node counted in the +Z direction from the wall surface 41 on a −Z side of the first outflow flow path 40).

The number of nodes of the standing waves SW1 to SW3 formed in each of the inflow flow path 20, the separation flow path 30, and the first outflow flow path 40 is not particularly limited. However, it is desirable that each of the standing wave SW2 of the separation flow path 30 and the standing wave SW3 of the first outflow flow path 40 has a plurality of nodes. Operation of fluid device 10

In the fluid device 10 of the present embodiment, as shown in FIG. 1, the standing waves SW1 to SW3 are formed in the respective flow paths of the inflow flow path 20, the separation flow path 30, and the first outflow flow path 40 by the ultrasonic transmitter 60 starting the transmission of the ultrasonic waves.

The inflow flow path 20 is supplied with the fluid containing microparticles from an arbitrary supply source (not shown), and the supplied fluid flows through the inflow flow path 20 along the X direction. The microparticles in the fluid flowing through the inflow flow path 20 are captured at a node position of the standing wave SW1 at least in a region immediately before the separation flow path 30, and move toward the separation flow path 30 along the flow of the fluid while being captured.

Since a flow path width is increased from the inflow flow path 20 to the separation flow path 30 (L₁<L₂), the fluid flowing into the separation flow path 30 from the inflow flow path 20 flows so as to spread in the +Z direction. At this time, when most of the microparticles in the fluid are released from a state of being captured at a node position of the standing wave SW1 in the inflow flow path 20, they are captured at a first node from a −Z side of the standing wave SW2 in the separation flow path 30 (specifically, a first node counted in the +Z direction from the wall surface 31 on a −Z side of the separation flow path 30) before spreading in the +Z direction, and move toward the first outflow flow path 40 along the flow of the fluid. Among the microparticles in the fluid, the microparticles that spread in the +Z direction together with the fluid are captured at a second node from a −Z side of the standing wave SW2 (specifically, a second node counted in the +Z direction from the wall surface 31 on a −Z side of the separation flow path 30), and move toward the first outflow flow path 40 along the flow of the fluid. That is, in the separation flow path 30, the microparticles in the fluid behave differently from the fluid, and are prevented from moving in the +Z direction.

Most of the microparticles in the fluid flowing from the separation flow path 30 into the first outflow flow path 40 are released from a state of being captured at a first or second node position from a −Z side of the standing wave SW2, and immediately become captured at a first or second node from a −Z side of the standing wave SW3 (specifically, a first or second node counted in the +Z direction from the wall surface 41 on a −Z side of the first outflow flow path 40). Then, they flow along the first outflow flow path 40 along the X direction with the fluid, and move toward the concentration port 43. Therefore, the concentration port 43 discharges a concentrated fluid, which is a fluid in which the microparticles are concentrated.

On the other hand, the fluid flowing from the separation flow path 30 into the second outflow flow path 50 flows through the second outflow flow path 50 along the X direction and moves toward the purification port 53. As described above, since the microparticles in the separation flow path 30 are prevented from moving in the +Z direction, the fluid flowing into the second outflow flow path 50 from the separation flow path 30 contains almost no microparticles. Therefore, the purification port 53 discharges a diluted fluid, which is a fluid from which the microparticles are diluted or removed.

### Operation and Effect of Present Embodiment

The fluid device 10 of the present embodiment is the fluid device 10 that separates the microparticles in the fluid using the ultrasonic waves, and includes the inflow flow path 20 through which the fluid flows, the separation flow path 30 through which the fluid flows from the inflow flow path 20, the first outflow flow path 40 that causes the fluid to flow out from the separation flow path 30, the second outflow flow path 50 that causes the fluid to flow out from the separation flow path 30, and the ultrasonic transmitter 60 that transmits the ultrasonic waves to the inflow flow path 20, the separation flow path 30 and the first outflow flow path 40, and forms the standing wave along a first direction (Z direction) in each flow path to which the ultrasonic waves are transmitted.

With such a configuration, the standing waves SW1 to SW3 are formed in the inflow flow path 20, the separation flow path 30 and the first outflow flow path 40, so that sound pressure can be appropriately applied to the microparticles not only in each flow path but also at a boundary portion between adjacent flow paths. By this, while the microparticles in the fluid flow through the respective flow paths of the inflow flow path 20, the separation flow path 30, and the first outflow flow path 40, it is possible to maintain a state in which the microparticles are captured at a node of any standing wave in the flow paths. Therefore, the behavior of the microparticles can be controlled immediately before the microparticles are captured by the node of the standing wave SW2 in the separation flow path 30 and immediately after the microparticles are released from the node of the standing wave SW2 in the separation flow path 30, and the microparticles can be guided to the first outflow flow path 40.

Therefore, according to the fluid device 10 of the present embodiment, the capturing efficiency of the microparticles is improved, it is possible to flow out a concentrated fluid having a high concentration of microparticles from the first outflow flow path 40.

In the present embodiment, each of the flow path width L₁ of the inflow flow path 20, the flow path width L₂ of the separation flow path 30, and the flow path width L₃ of the first outflow flow path 40 in the first direction is an integral multiple of a half wavelength of the ultrasonic wave transmitted from the ultrasonic transmitter 60.

According to such a configuration, the standing waves SW1 to SW3 can be suitably formed in each of the inflow flow path 20, the separation flow path 30, and the first outflow flow path 40.

In the present embodiment, each of the flow path width L₂ of the separation flow path 30 and the flow path width L₃ of the first outflow flow path 40 is an integral multiple of the flow path width L₁ of the inflow flow path 20.

According to such a configuration, a Z-direction position (Z position) of a node of the standing wave SW1 in the inflow flow path 20 coincides with the Z position of any node of the standing wave SW2 in the separation flow path 30, and the Z position of any node of the standing wave SW3 in the first outflow flow path 40. This stabilizes the flow of the microparticles from the inflow flow path 20 until reaching the first outflow flow path 40, whereby high concentration efficiency can be obtained.

The ultrasonic transmitter 60 of the present embodiment includes an ultrasonic element arranged across the inflow flow path 20, the separation flow path 30 and the first outflow flow path 40. By this, since the ultrasonic transmitter 60 can be configured by one ultrasonic element, it is possible to reduce the cost of the fluid device 10.

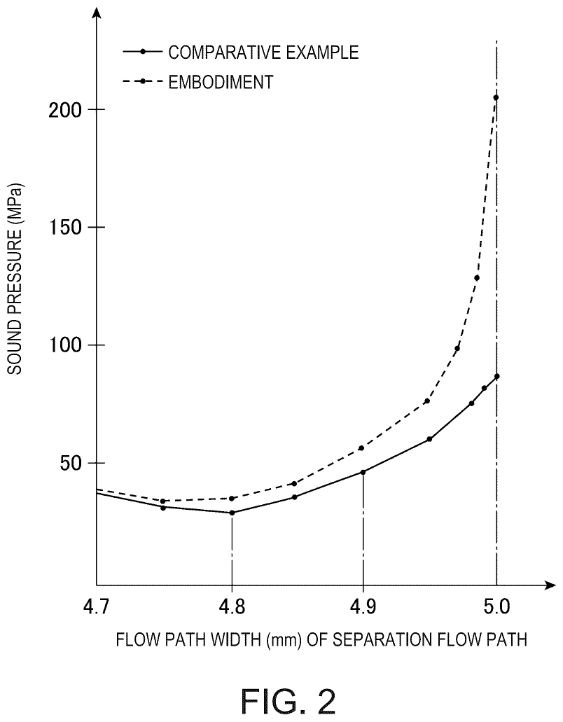

FIG. 2 is a graph showing a simulation result for explaining the effect of the present embodiment. This simulation is to measure the sound pressure applied to the microparticles at a boundary portion between the separation flow path 30 and the first outflow flow path 40. In the simulation of the embodiment, the sound pressure applied to the microparticles when the ultrasonic waves were transmitted to each flow path of the separation flow path 30 and the first outflow flow path 40 was measured, and in the simulation of a comparative example, the sound pressure applied to the microparticles when the ultrasonic waves were transmitted only to the separation flow path 30 was measured. In each of the embodiment and the comparative example, measurements were performed each time the flow path width L₂ of the separation flow path 30 was increased from a predetermined value (for example, 4.7 mm) by a predetermined interval until the flow path width L₂ of the separation flow path 30 reached a value (for example, 5.0 mm) that satisfied the above-described formula (1).

As shown in FIG. 2, when the flow path width L₂ of the separation flow path 30 satisfies the above-described formula (2) (for example, when at 5.0 mm), a remarkably large sound pressure is applied to the microparticles in the embodiment as compared with the comparative example. That is, in the embodiment, it is clear that sound pressure is suitably applied to the microparticles at a boundary portion between the separation flow path 30 and the first outflow flow path 40.

In the present embodiment, it is assumed that a slight error can be tolerated as long as the condition of the above-described formula (2) is within a range capable of capturing microparticles.

For example, in the simulation of FIG. 2, the effect of the embodiment appears when the wavelength of the ultrasonic waves transmitted from the ultrasonic transmitter 60 is 1 mm and the flow path width L₂ of the separation flow path 30 is 4.9 mm to 5.0 mm. Therefore, it is considered that an error of approximately 1/10 of the wavelength of the ultrasonic wave transmitted from the ultrasonic transmitter 60 can be tolerated.

### Second Embodiment

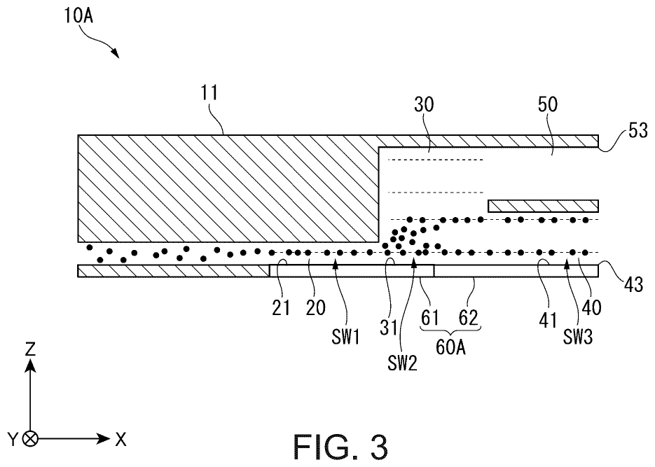

A second embodiment will be described with reference to FIG. 3. A fluid device 10A of the second embodiment includes an ultrasonic transmitter 60A including a configuration different from that of the first embodiment.

The ultrasonic transmitter 60A includes, as a plurality of ultrasonic elements, a first ultrasonic element 61 arranged from the inflow flow path 20 to the separation flow path 30 and a second ultrasonic element 62 arranged from the separation flow path 30 to the first outflow flow path 40. Specifically, the first ultrasonic element 61 is provided in the flow path member 11 so as to form a partial region (a region adjacent to the separation flow path 30) of the wall surface 21 of the inflow flow path 20 and a partial region on a −X side of the wall surface 31 of the separation flow path 30. The second ultrasonic element 62 is provided in the flow path member 11 so as to form a partial region on a +X side of the wall surface 31 of the separation flow path 30 and the wall surface 41 of the first outflow flow path 40.

Here, it is desirable that the first ultrasonic element 61 and the second ultrasonic element 62 are adjacent to each other in the X direction, but a gap in the X direction (that is, a wall surface by the flow path member 11) may be present between the first ultrasonic element 61 and the second ultrasonic element 62.

Each of the first ultrasonic element 61 and the second ultrasonic element 62 may be a bulk type ultrasonic element or a thin film type ultrasonic element as in the first embodiment.

In the present embodiment, the first ultrasonic element 61 and the second ultrasonic element 62 desirably transmit ultrasonic waves of equal frequency to each other, and form the standing waves SW1 to SW3 in the respective flow paths of the inflow flow path 20, the separation flow path 30, and the first outflow flow path 40.

In the fluid device 10A of the second embodiment described above, the capturing efficiency of the microparticles can be improved as in the first embodiment.

### Third Embodiment

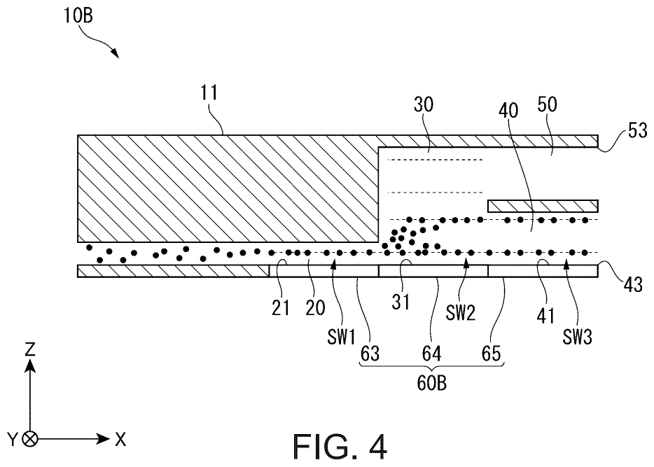

A third embodiment will be described with reference to FIG. 4. A fluid device 10B of the third embodiment includes an ultrasonic transmitter 60B having a configuration different from that of the first embodiment.

The ultrasonic transmitter 60B includes, as a plurality of ultrasonic elements, a first ultrasonic element 63 provided in the inflow flow path 20, a second ultrasonic element 64 provided in the separation flow path 30, and a third ultrasonic element 65 provided in the first outflow flow path 40. Specifically, the first ultrasonic element 63 is provided in the flow path member 11 so as to form a partial region of the wall surface 21 of the inflow flow path 20, specifically, a region adjacent to the separation flow path 30. The second ultrasonic element 64 is provided in the flow path member 11 so as to form the wall surface 31 of the separation flow path 30. The third ultrasonic element 65 is provided in the flow path member 11 so as to form the wall surface 41 of the first outflow flow path 40.

Here, it is desirable that the first ultrasonic element 63 and the second ultrasonic element 64 are adjacent to each other in the X direction, but a gap in the X direction (that is, a wall surface by the flow path member 11) may be present between the first ultrasonic element 63 and the second ultrasonic element 64. The same applies to the arrangement relationship between the second ultrasonic element 64 and the third ultrasonic element 65.

Each of the first ultrasonic element 63, the second ultrasonic element 64, and the third ultrasonic element 65 may be a bulk type ultrasonic element or a thin film type ultrasonic element.

In the present embodiment, the first ultrasonic element 63, the second ultrasonic element 64, and the third ultrasonic element 65 desirably transmit ultrasonic waves of equal frequency, and form the standing waves SW1 to SW3 in the inflow flow path 20, the separation flow path 30, and the first outflow flow path 40, respectively.

In the fluid device 10B of the third embodiment described above, the capturing efficiency of the microparticles can be improved as in the first embodiment.

### Fourth Embodiment

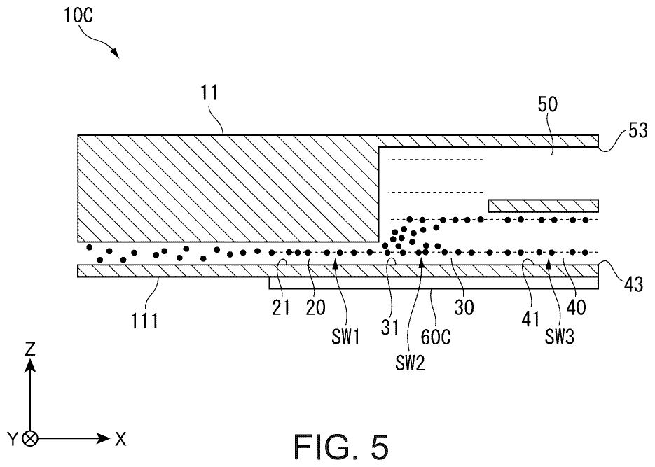

A fourth embodiment will be described with reference to FIG. 5. A fluid device 10C of the fourth embodiment includes an ultrasonic transmitter 60C arranged differently from the first embodiment.

In the present embodiment, as in the first embodiment, the ultrasonic transmitter 60C is arranged across the inflow flow path 20, the separation flow path 30, and the first outflow flow path 40, and transmits ultrasonic waves to these flow paths.

However, in the present embodiment, each wall surface 21, 31, and 41 of the inflow flow path 20, the separation flow path 30 and the first outflow flow path 40 is formed by the flow path member 11, and the ultrasonic transmitter 60C is provided on a wall section 111 of the flow path member 11 that forms each wall surface 21, 31, and 41. Therefore, the ultrasonic transmitter 60C transmits ultrasonic waves to the inflow flow path 20, the separation flow path 30, and the first outflow flow path 40 via the wall section 111 to form the standing waves SW1 to SW3 in the respective flow paths.

In the fluid device 10C of the present embodiment, the capturing efficiency of the microparticles can be improved as in the first embodiment.

Although the ultrasonic transmitter 60C of the fourth embodiment is constituted by one ultrasonic element, it may be constituted by a plurality of ultrasonic elements as in the second or third embodiment.

### Fifth Embodiment

A fluid device of a fifth embodiment basically includes the same configuration as that of the fluid device 10 of the first embodiment shown in FIG. 1, but is different from the first embodiment in a material constituting the partition 112 between the first outflow flow path 40 and the second outflow flow path 50.

Specifically, a portion of the flow path member 11 other than the partition 112 is formed of a material capable of reflecting the ultrasonic waves in the fluid, similarly to the first embodiment.

On the other hand, the partition 112 is made of a material capable of transmitting the ultrasonic waves in the fluid (ultrasonic wave transmitting material). A specific example of the ultrasonic wave transmitting material is not particularly limited, and a material having an acoustic impedance close to that of the fluid can be used.

In the present embodiment, the capturing efficiency of the microparticles can be improved as in the first embodiment. In the present embodiment, without being limited to the flow path width L₃ of the first outflow flow path 40, it is possible to form a stable standing wave in the first outflow flow path 40.

The fifth embodiment includes the same ultrasonic transmitter 60 as that of the first embodiment, but may include any one of the ultrasonic transmitters 60A to 60C of the second to fourth embodiments.

### Modifications

The present disclosure is not limited to the above-described embodiments, and configurations obtained by modifications, improvements, appropriate combinations of the embodiments, and the like within a range in which the object of the present disclosure can be achieved are included in the present disclosure.

In each of the above-described embodiments, cases where the ultrasonic transmitters 60, 60A to 60C include one to three ultrasonic elements have been described, but the present disclosure is not limited thereto, and the ultrasonic transmitters 60, 60A to 60C may include more ultrasonic elements. For example, in each of the above-described embodiments, the ultrasonic transmitters 60, 60A to 60C may include a plurality of ultrasonic elements arranged continuously or intermittently along at least one of the X direction and the Y direction.

In each of the above-described embodiments, for simplicity of description, the number of nodes of the standing wave formed in the inflow flow path 20 is one, but may be a plurality.

In each of the above-described embodiments, each of the flow path width L₂ of the separation flow path 30 and the flow path width L₃ of the first outflow flow path 40 is an integral multiple of the flow path width L₁ of the inflow flow path 20, and the respective standing waves SW1 to SW3 formed in the inflow flow path 20, the separation flow path 30, and the first outflow flow path 40 have nodes arranged at the same positions in the Z direction, but the present disclosure is not limited to this. For example, Z positions of nodes in the respective flow paths may be shifted so that the microparticles flow between the flow paths in the X direction and move to the −Z position.

In each of the above-described embodiments, the inflow flow path 20, the separation flow path 30, the first outflow flow path 40, and the second outflow flow path 50 are arranged along the X direction, and the fluid flows along the X direction, but the present disclosure is not limited thereto. For example, each of the inflow flow path 20, the separation flow path 30, the first outflow flow path 40, and the second outflow flow path 50 may be arranged along a direction intersecting with respect to the Z direction (a direction in which the standing wave is formed), such as the Y direction, and the fluid may be allowed to flow along the direction.

In the second and third embodiments, the frequencies of the ultrasonic waves transmitted by the ultrasonic elements constituting the ultrasonic transmitters 60A and 60B are equal to each other, but the present disclosure is not limited thereto. For example, when each of the standing waves SW1 to SW3 formed in the inflow flow path 20, the separation flow path 30 and the first outflow flow path 40 has nodes arranged at the same positions as each other in the Z direction, each ultrasonic element may transmit ultrasonic waves of the same frequency.

As a modification of the third embodiment, the wall surfaces 21, 31, and 41 on a −Z side of each of the inflow flow path 20, the separation flow path 30 and the first outflow flow path 40 may be arranged at different positions in the Z direction. In other words, the first ultrasonic element 63, the second ultrasonic element 64, and the third ultrasonic element 65 may be arranged at positions different from each other in the Z direction.

The ultrasonic transmitters 60, 60A to 60C in each of the above-described embodiments transmit ultrasonic waves to the inflow flow path 20, the separation flow path 30, and the first outflow flow path 40, but the present disclosure is not limited to this, and ultrasonic waves may be transmitted to one of the inflow flow path 20 or the first outflow flow path 40 and the separation flow path 30.

For example, in the second embodiment, either the first ultrasonic element 61 or the second ultrasonic element 62 may be omitted, and instead, the flow path member 11 may form a wall surface. In the third embodiment, either the first ultrasonic element 63 or the third ultrasonic element 65 may be omitted, and the flow path member 11 may form a wall surface.

In these modifications, since the behavior of the microparticles can be controlled either immediately before the microparticles are captured by the node of the standing wave SW2 in the separation flow path 30 or immediately after the microparticles are released from the node of the standing wave SW2 in the separation flow path 30, the concentration efficiency of the microparticles can be improved as compared with the related art.

In these modifications, the flow path width of either the inflow flow path 20 or the first outflow flow path 40 through which the ultrasonic waves are not transmitted may not be an integral multiple of a half wavelength of the ultrasonic wave.

### Outline of Present Disclosure

A fluid device according to a first aspect of the present disclosure is a fluid device that separates microparticles in a fluid using ultrasonic waves, the fluid device including an inflow flow path through which the fluid flows; a separation flow path into which the fluid flows from the inflow flow path; a first outflow flow path that causes the fluid to flow out from the separation flow path; a second outflow flow path that causes the fluid to flow out from the separation flow path; and an ultrasonic transmitter that transmits the ultrasonic waves to the separation flow path and at least one of the inflow flow path and the first outflow flow path, and forms a standing wave along a first direction in each flow path to which the ultrasonic waves were transmitted.

According to the fluid device of the present embodiment, it is possible to control the behavior of the microparticles immediately before the microparticles are captured by the node of the standing wave in the separation flow path or immediately after the microparticles are released from the node of the standing wave in the separation flow path, so that the capturing efficiency of the microparticles can be improved.

The fluid device of the present aspect may be configured such that each of a flow path width of the inflow flow path, a flow path width of the separation flow path, and a flow path width of the first outflow flow path in the first direction is an integral multiple of a half wavelength of the ultrasonic waves transmitted from the ultrasonic transmitter.

By this, the standing wave can be suitably formed in each of the inflow flow path, the separation flow path, and the first outflow flow path.

The fluid device of the present aspect may be configured such that each of the flow path width of the separation flow path and the flow path width of the first outflow flow path is an integral multiple of the flow path width of the inflow flow path.

This stabilizes the flow of the microparticles from the inflow flow path to the first outflow flow path, it is possible to obtain the high concentration efficiency.

The fluid device of the present aspect may be configured such that the ultrasonic transmitter includes an ultrasonic element arranged across the inflow flow path, the separation flow path, and the first outflow flow path.

The fluid device of the present aspect may be configured such that the ultrasonic transmitter includes a plurality of ultrasonic elements.

For example, the fluid device of the present aspect may be configured such that the ultrasonic transmitter includes a first ultrasonic element arranged from the inflow flow path to the separation flow path, and a second ultrasonic element arranged from the separation flow path to the first outflow flow path.

The fluid device of the present aspect may be configured such that the ultrasonic transmitter includes a first ultrasonic element arranged in the inflow flow path, a second ultrasonic element arranged in the first outflow flow path, and a third ultrasonic element arranged in the separation flow path.

The fluid device of the present aspect may be configured such that the fluid device further includes a partition that partitions between the first outflow flow path and the second outflow flow path, wherein the partition is made of a material that transmits the ultrasonic waves.

What is claimed is:

1. A fluid device that separates microparticles in a fluid using ultrasonic waves, the fluid device comprising:
an inflow flow path through which the fluid flows;
a separation flow path into which the fluid flows from the inflow flow path;
a first outflow flow path that causes the fluid to flow out from the separation flow path;
a second outflow flow path that causes the fluid to flow out from the separation flow path; and
an ultrasonic transmitter that transmits the ultrasonic waves to the separation flow path and at least one of the inflow flow path and the first outflow flow path, and forms a standing wave along a first direction in each flow path to which the ultrasonic waves were transmitted.

2. The fluid device according to claim 1, wherein
each of a flow path width of the inflow flow path, a flow path width of the separation flow path, and a flow path width of the first outflow flow path in the first direction is an integral multiple of a half wavelength of the ultrasonic waves transmitted from the ultrasonic transmitter.

3. The fluid device according to claim 2, wherein
each of the flow path width of the separation flow path and the flow path width of the first outflow flow path is an integral multiple of the flow path width of the inflow flow path.

4. The fluid device according to claim 2, wherein
the ultrasonic transmitter includes an ultrasonic element arranged across the inflow flow path, the separation flow path, and the first outflow flow path.

5. The fluid device according to claim 2, wherein
the ultrasonic transmitter includes a plurality of ultrasonic elements.

6. The fluid device according to claim 5, wherein
the ultrasonic transmitter includes a first ultrasonic element arranged from the inflow flow path to the separation flow path, and a second ultrasonic element arranged from the separation flow path to the first outflow flow path.

7. The fluid device according to claim 5, wherein
the ultrasonic transmitter includes a first ultrasonic element arranged in the inflow flow path, a second ultrasonic element arranged in the first outflow flow path, and a third ultrasonic element arranged in the separation flow path.

8. The fluid device according to claim 1, further comprising:
a partition that partitions between the first outflow flow path and the second outflow flow path in the first direction, wherein
the ultrasonic transmitter transmits the ultrasonic waves to at least the separation flow path and the first outflow flow path and
the partition is made of a material that transmits the ultrasonic waves.
